(19) United States
(12) Patent Application Publication
(10) Pub. No.: US 2014/0104207 A1
(43) Pub. Date: Apr. 17, 2014

(54) METHOD OF PROVIDING TOUCH EFFECT AND ELECTRONIC DEVICE THEREFOR

(71) Applicant: Samsung Electronics Co., Ltd., Suwon-si (KR)

(72) Inventors: Chan-Woo PARK, Seongnam-si (KR); Nam-Hoi KIM, Suwon-si (KR); Sun-Young MIN, Suwon-si (KR)

(73) Assignee: Samsung Electronics Co., Ltd., Suwon-si (KR)

(21) Appl. No.: 14/034,984

(22) Filed: Sep. 24, 2013

(30) Foreign Application Priority Data
Oct. 15, 2012 (KR) 10-2012-0114217

(51) Int. Cl. G06F 3/041

(52) U.S. Cl. CPC G06F 3/041
USPC 345/173

(57) ABSTRACT

A method and apparatus for providing an effect corresponding to an input touch in an electronic device is provided. The method includes displaying an image, detecting a touch for the displayed image and outputting a feedback effect according to a trace of the detected touch and previously stored material information of the image, wherein the material information includes at least one of flexion, strength, and a friction coefficient of a target indicated by the image and information in which a surface of the target is sampled.

### PRIORITY

This application claims the benefit under 35 U.S.C. §119(a) of a Korean patent application filed on Oct. 15, 2012 in the Korean Intellectual Property Office and assigned Serial No. 10-2012-0114217, the entire disclosure of which is hereby incorporated by reference.

### BACKGROUND OF THE INVENTION

1. Field of the Invention

The present invention relates to a touch. More particularly, the present invention relates to a method and apparatus for providing an effect corresponding to an input touch in an electronic device.

2. Description of the Related Art

Recently, as electronic devices such as smart phones and tablet Personal Computers (PCs) have been rapidly developed, the electronic devices are becoming capable of performing wireless voice communication and exchanging information. Portable communication devices were originally only capable of performing wireless communication. However, as technologies of the electronic devices have been developed and wireless internes has been introduced, the electronic devices have been developed into multimedia devices capable of a scheduling function, a game function, a remote control function, a photographing function, a projector function, and the like to satisfy needs of users. Accordingly, the electronic devices for providing a plurality of functions have become necessities of life.

Recently, touch screens capable of simultaneously performing input and output have been released to the market. Accordingly, various User Interfaces (UIs) for touching the touch screens have been provided. An electronic device having the touch screen may detect a touch of a user and output a result according to the detected touch. For example, when a touch of a displayed specific button is detected, the electronic device having the touch screen outputs a vibration effect or a sound effect mapped to the specific button. However, because a UI for outputting a result according to the detected touch always provides the same effect for the touch of the user, the UI does not satisfy various needs of users. Accordingly, there is a need for a method and apparatus for providing various touch effects capable of satisfying various needs of users.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for providing a touch effect in an electronic device.

Another aspect of the present invention is to provide a method and apparatus for providing a feedback effect for a touch according to pressure and speed of the touch in an electronic device.

Another aspect of the present invention is to provide a method and apparatus for setting a plurality of material information to respective images and providing a feedback effect for a touch according to the material information in an electronic device.

Another aspect of the present invention is to provide a method and apparatus for providing a feedback effect for a touch according to a type of a writing instrument in an electronic device.

In accordance with an aspect of the present invention, a touch input method of an electronic device is provided. The touch input method includes displaying an image, detecting a touch for the displayed image and outputting a feedback effect according to a trace of the detected touch and previously stored material information of the image, wherein the material information includes at least one of flexion, strength, and a friction coefficient of a target indicated by the image and information in which a surface of the target is sampled.

In accordance with another aspect of the present invention, a touch input device for an electronic device is provided. The touch input device includes at least one processor, a touch-sensitive display, at least one feedback output device, a memory, and one or more programs, each of which are stored in the memory and configured to be executed by the one or more processors, wherein the programs include an instruction for displaying an image, for detecting a touch for the displayed image, and for outputting a feedback effect according to a trace of the detected touch and previously stored material information of the image, wherein the at least one feedback output device includes at least one of a display device, a vibration generating device, and a sound output device, and wherein the material information includes at least one of a flexion, a strength, and a friction coefficient of a target indicated by the image and information in which a surface of the target is sampled.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A is a block diagram illustrating a configuration of an electronic device for outputting a touch feedback effect according to an embodiment of the present invention;

FIG. 1B is a block diagram illustrating detailed configuration of a processor for outputting a touch feedback effect according to an embodiment of the present invention;

FIG. 1C illustrates a process of determining a vibration generation time point and vibration strength in an electronic device according to an embodiment of the present invention;

FIG. 1D illustrates a process of performing 3D sampling of a target indicated by an image and storing material information in an electronic device according to an embodiment of the present invention;

FIG. 1E illustrates material information by stored images in an electronic device according to an embodiment of the present invention;

FIG. 1F illustrates vibration values calculated based on vibration generation time points and vibration strength in an electronic device according to an embodiment of the present invention;

FIGS. 2A and 2B illustrate information which is written down on a wood material image and a sand material image in an electronic device according to an embodiment of the present invention;

FIG. 3A is a flowchart illustrating a process of outputting a feedback effect for touch input in an electronic device according to an embodiment of the present invention;

FIG. 3B is a block diagram illustrating configuration of an apparatus for outputting a feedback effect for touch input in an electronic device according to an embodiment of the present invention;

FIG. 4A is a flowchart illustrating a process of outputting a feedback effect according to material information of an image in touch input in an electronic device according to an embodiment of the present invention;

FIG. 4B is a flowchart illustrating a process of outputting a feedback effect according to material information of an image in touch input in an electronic device according to an embodiment of the present invention;

FIG. 4C illustrates a process of verifying material information of a stored image according to a touch progress length in an electronic device according to an embodiment of the present invention;

FIG. 5A is a flowchart illustrating a process of outputting a feedback effect for touch input in the touch input using a writing instrument in an electronic device according to an embodiment of the present invention;

FIG. 5B is a flowchart illustrating a process of outputting a feedback effect for touch input in the touch input using a writing instrument in an electronic device according to an embodiment of the present invention;

FIG. 5C illustrates writing instrument icons in an electronic device according to an embodiment of the present invention;

FIG. 5D illustrates type information by writing instruments in an electronic device according to an embodiment of the present invention;

FIG. 5E illustrates a process of determining vibration strength by writing instruments in an electronic device according to an embodiment of the present invention;

FIG. 6A is a flowchart illustrating a process of outputting a feedback effect based on writing pressure and writing speed of a touch in the touch input in an electronic device according to an embodiment of the present invention;

FIG. 6B is a flowchart illustrating a process of outputting a feedback effect based on writing pressure and writing speed of a touch in the touch input in an electronic device according to an embodiment of the present invention;

FIG. 7A is a flowchart illustrating a process of outputting a feedback effect based on writing pressure and writing speed in the touch input using a writing instrument in an electronic device according to an embodiment of the present invention; and

FIG. 7B is a flowchart illustrating a process of outputting a feedback effect based on writing pressure and writing speed in the touch input using a writing instrument in an electronic device according to an embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device may include at least one of a mobile communication terminal, a smart phone, a tablet PC, a digital camera, a Moving Picture Experts Group (MPEG)-1 audio layer-3 (MP3) player, a navigation device, a laptop computer, a netbook, a computer, a television, a refrigerator, an air conditioner, etc., which may receive touch input.

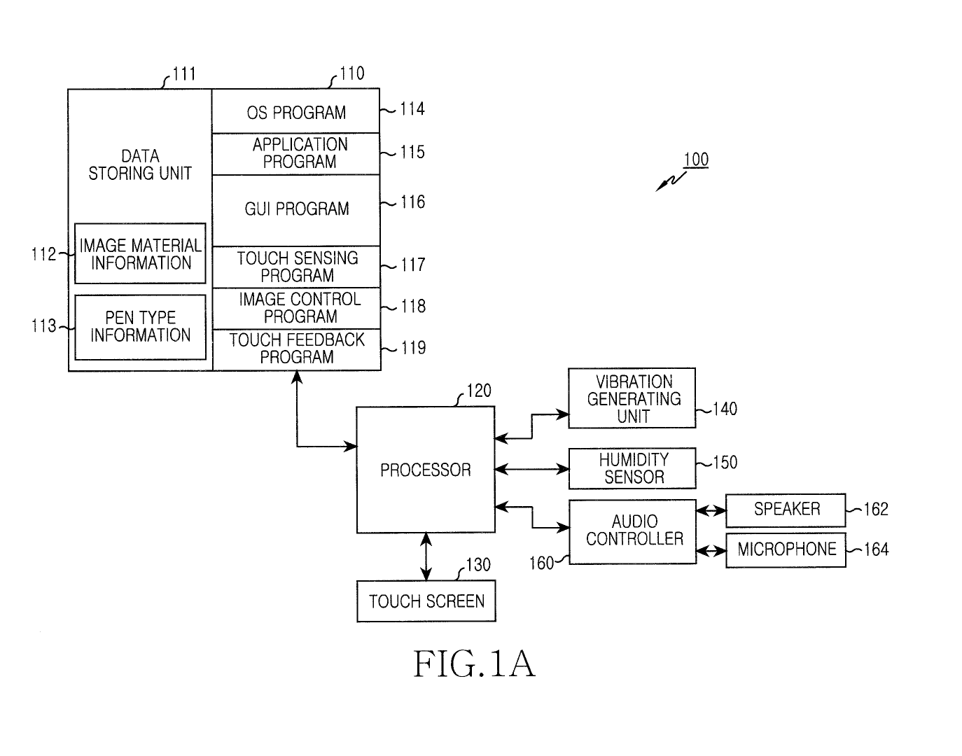

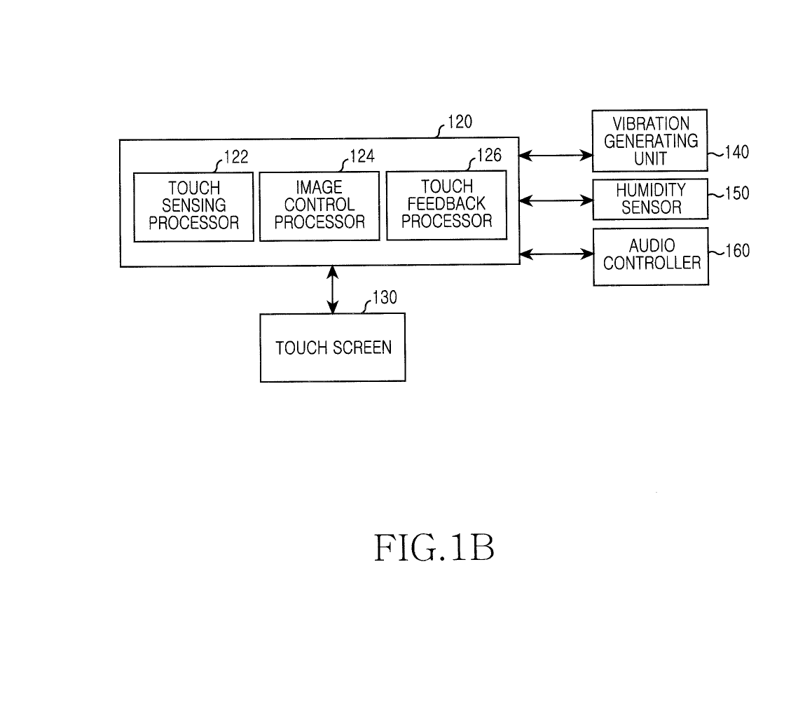

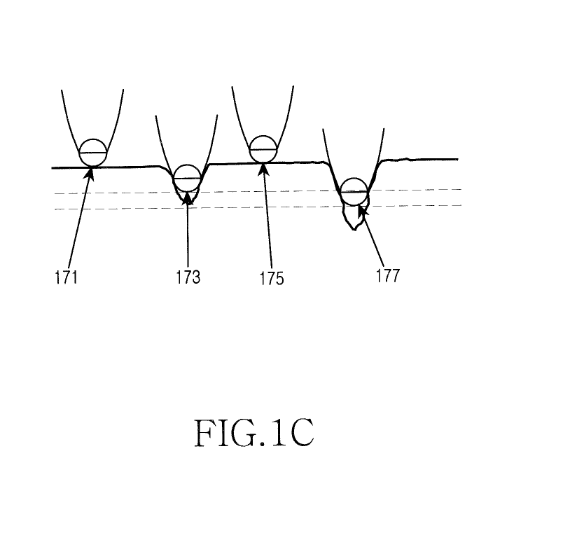

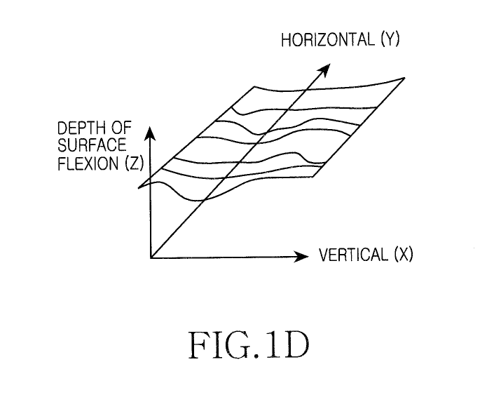

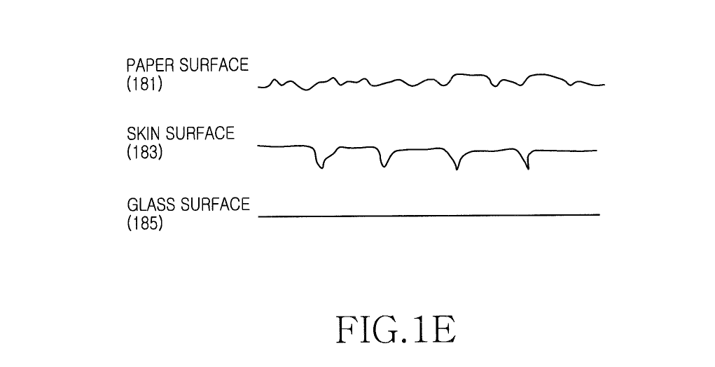

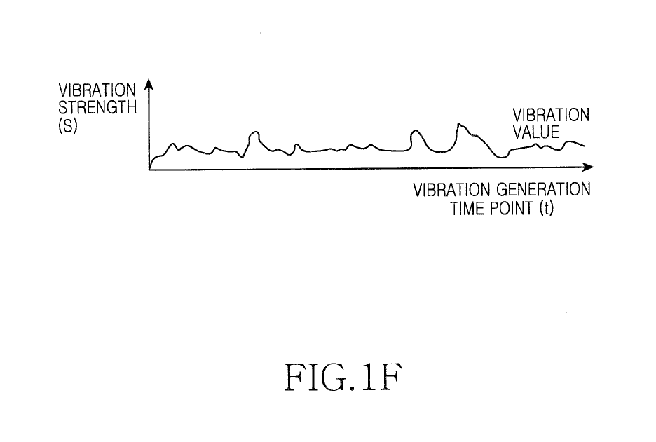

FIG. 1A is a block diagram illustrating configuration of an electronic device for outputting a touch feedback effect according to an embodiment of the present invention.

Referring to FIG. 1A, the electronic device 100 includes a memory 110, a processor 120, a touch screen 130, a vibration generating unit 140, a humidity sensor 150, and an audio controller 160. The memory 110 and the processor 120 may be a plurality of memories and processors, respectively.

The memory 110 includes a data storing unit 111, an Operating System (OS) program 114, an application program 115, a Graphic User Interface (GUI) program 116, a touch sensing program 117, an image control program 118, a touch feedback program 119, etc. The programs which are software components may be expressed in a set of instructions. Accordingly, the programs are expressed in an instruction set. Also, the programs are expressed in modules.

The memory 110 may store one or more programs including instructions for performing embodiments of the present invention.

The data storing unit 111 stores data items generated when functions corresponding to the programs stored in the memory 110 are performed. The data storing unit 111 may store image material information 112 by the image control program 118. The image material information 112 may include information indicating a surface, flexion height, roughness, and a shape of a target. The data storing unit 111 may map predetermined material information corresponding to a target indicated by an image to each coordinate of the image and store the mapped information. For example, as shown in FIG. 1D, the data storing unit 111 may perform 3-Dimensional (3D) sampling of a paper surface, a skin surface, and a glass surface, and, as shown in FIG. 1E, store the 3D sampled information as material information about a paper surface 181, a skin surface 183, and a glass surface 185. In addition, the data storing unit 111 may store material information of an image for a touch progress length.

The data storing unit 111 may store a friction coefficient for each image. This is to determine vibration values according to friction coefficients to differ from each other in case of different targets having the same material information. For example, an image of glass material and an image of iron material have the same material information. However, because the image of the glass material and the image of the iron material have different friction coefficients, they have different vibration values. Herein, the higher a friction coefficient, the higher a vibration value of each image.

The data storing unit 111 may also store a pen type information 113 while being classified according to writing instruments. The pen type information 113 may include information indicating features of a pen such as hardness, thickness, and strength of a pen tip.

The OS program 114 (e.g., embedded OS such as Windows, Linux, Darwin, RTXC, UNIX, OS X, VxWorks, and the like) includes several software components for controlling a general system operation. For example, control of this general system operation may include memory management and control, storage hardware (device) control and management, power control and management, etc. The OS program 114 also performs a function for smoothly communicating between several hardware components (devices) and software components (programs).

The application program 115 includes applications, such as a browser function application, an email function application, a message function application, a word processing function application, an address book function application, a widget function application, a Digital Rights Management (DRM) function application, a voice recognition function application, a voice copy function application, a position determining function application, a location based service function application, a call function application, a gallery function application, and the like.

The GUI program 116 includes at least one software component for providing a UI using graphics between the user and the electronic device 100. The GUI program 116 includes at least one software component for displaying UI information on the touch screen 130. The GUI program 116 according to may include an instruction for displaying an image indicating material of a specific target on the touch screen 130. The target includes at least one of paper, metal, wood, plastic, stone, sand, skin, glass, and water. For example, the GUI program 114 may include an instruction for displaying an image indicating wood material. The GUI program 116 may also include an instruction for displaying an image indicating glass material.

The GUI program 116 may also include an instruction for displaying effects by images generated by the image control program 118. For example, the GUI program 116 may include an instruction for displaying an effect in which sand on a position where writing data is input is dug and sand around the position where the writing data is input is accumulated while displaying graphics such as the writing data corresponding to an input touch is directly input to sand. The GUI program 116 may include an instruction for displaying an effect in which wood on a position where writing data is input is dug and pieces of the dug wood are scattered while displaying graphics such as the writing data corresponding to an input touch is input to wood.

The GUI program 116 may include an instruction for displaying writing instrument selection items. The writing instrument includes at least one of a pencil, a brush, a highlighter, a ballpoint pen, a colored pencil, a crayon, a fountain pen, and an eraser.

The touch sensing program 117 interworks with the touch screen 130 and detects touch input on a touch sensing surface. The touch sensing program 117 determines whether a touch is generated on a touch sensing surface, determines a movement of the touch, determines a movement direction and time of the touch, and determines whether the touch is stopped. Determining the movement of the touch may include determining a movement speed (magnitude), movement velocity (magnitude and direction), acceleration (including magnitude or/and direction) of the touch, and the like. The touch sensing program 117 may detect a touch of a user and verify writing pressure and writing speed of the sensed touch. The writing pressure and writing speed of the touch may include writing pressure and writing speed. According to an embodiment of the present invention, the writing pressure and writing speed of the touch means pressure and movement speed of a touch which is provided to the touch screen 130.

The image control program 118 displays an image. The displayed image includes the image material information 112. The image control program 118 displays surface flexion and a surface feature of a target indicated by the image. The displayed target includes at least one of paper, metal, wood, plastic, stone, sand, skin, glass, and water. For example, the image control program 118 may display an image indicating wood material or an image indicating plastic material.

When a touch is detected by the touch sensing program 117, the image control program 118 may display writing data corresponding to the sensed touch on a displayed image. The image control program 118 may display writing data on a displayed target in consideration of material of an image displayed by the touch feedback program 119. For example, when a touch which progresses in a straight line on an image indicating wood material is detected, the image control program 118 may display a line of a crooked shape partially on a portion where a change value of surface flexion is greater than or equal to a threshold value while the touch progresses in a straight line, in consideration of material information of wood indicated by the image, instead of displaying writing data of the straight line, and output an effect such as the user writing the data directly on the wood. Similarly, when a touch of a curve is sensed on an image indicating sand material, the image control program 118 may display an effect in which sand of a portion where the touch of the curve is input is dug and sand around the curve is thickly accumulated and output an effect such as the user writing data directly on sand. When a touch is sensed on an image indicating water material, the image control program 118 may display an effect in which environs of writing data are rippled according to the writing data corresponding to the detected touch.

When humidity of a threshold value or more is sensed by the humidity sensor 150, the image control program 118 may display a frost effect on a displayed image. When a touch is sensed on the image having the frost effect, the image control program 118 may display an effect in which the image is defrosted according to writing data corresponding to the detected touch.

The touch feedback program 119 generates a feedback effect based on at least one of the writing pressure and writing speed of the touch verified by the touch sensing program 117, the image material information 112, and the pen type information 113.

A touch is input to a surface of the touch screen 130 in which there is no flexion. According to an embodiment of the present invention, the touch feedback program 119 generates a vibration effect such as the user inputting a touch to a corresponding target directly, in consideration of material information of the target indicated by an image. The touch feedback program 119 generates a vibration effect based on material information mapped to a coordinate of an image to which a touch is input, a tip of a touch subject, and a speed and pressure of the touch subject. The touch feedback program 119 may also generate a vibration effect based on material information of an image according to a progress distance of a touch, the tip of a touch subject, and the speed and pressure of the touch subject.

The touch feedback program 119 generates a vibration effect. The touch feedback program 119 generates vibration per time point when tip of a touch subject bumps against surface flexion of a displayed target in consideration of material information of a target indicated by a displayed image. For example, as shown in FIG. 1C, the touch feedback program 119 generates vibration in time points 173 and 177 when the tip of a touch subject bumps in a section where a change value of a surface flexion of a displayed target is greater than or equal to a threshold value. The touch feedback program 119 does not generate vibration in time points 171 and 175 when the tip of the touch subject bumps in a section where a change value of the surface flexion is less than or equal to a threshold value, such as a section which is similar to a plane. In addition, the quicker the writing speed of a touch, the quicker a time point when the tip of the touch subject bumps against a section where a change value of surface flexion of a displayed target is greater than or equal to a threshold value. Accordingly, the quicker the writing speed of the touch, the quicker the generation speed of vibration generated by the touch feedback program 119.

In addition, the touch feedback program 119 may adjust strength of vibration according to pressure of the touch sensed by the touch sensing program 117. The stronger the intensity of the pressure of the touch sensed by the touch sensing program 117, the stronger the touch feedback program 119 may set strength of vibration. The touch feedback program 119 may also adjust strength of vibration according to height at which touch subjects fall onto surface flexion of a displayed target. The higher the height at which the touch subjects fall onto the surface flexion of the displayed target, the stronger the touch feedback program 119 increases strength of vibration. The lower the height at which the touch subjects fall onto the surface flexion of the displayed target, the weaker the touch feedback program 119 decreases strength of vibration. For example, as shown in FIG. 1C, the touch feedback program 119 may generate the strongest vibration in a time point 177 when the height at which the touch subject falls is the highest height among the time points 173 and 177 when vibration is generated.

The touch feedback program 119 may adjust the strength of vibration according to a writing instrument item selected by the user. The stronger the material strength of a selected writing instrument, the stronger the touch feedback program 119 may increase strength of generated vibration. For example, when a ballpoint pen with strong material strength is selected among writing instruments, the touch feedback program 119 may generate stronger vibration than when a brush with weak material strength is selected. In addition, as shown in FIG. 1E, the electronic device 100 may calculate a vibration value based on vibration strength and a vibration generation time point.

In addition, the touch feedback program 119 may generate a sound effect using the calculated vibration value. The touch feedback program 119 may generate a sound in a time point when vibration is generated. The more vibration strength is increased, the more the touch feedback program 119 may increase volume or a frequency of a sound. The touch feedback program 119 may also generate a sound effect according to material of a displayed image. For example, when a displayed image has paper material, the touch feedback program 119 may generate a sound effect generated by a writing instrument and paper when the user writes down data actually on paper. When a displayed image has wood material, the touch feedback program 119 may generate a sound effect generated by a writing instrument and wood when the user writes down data on wood.

In addition, the touch feedback program 119 may generate a graphic effect. The generated graphic effect may include an effect indicating a shape in which a target is changed according to target material of a displayed image when writing data is input. For example, when a touch is detected on an image indicating sand material, the touch feedback program 119 may display an effect in which surrounding sand is scattered according to writing data corresponding to the detected touch. When a touch is detected on an image indicating water material, the touch feedback program 119 may display an effect in which surrounding water is rippled according to writing data corresponding to the detected touch.

Although not shown in FIG. 1A, the processor 120 may include at least one processor and a peripheral interface. The processor 120 executes a specific program (instruction set) stored in the memory 110 and performs a plurality of specific functions corresponding to the program.

The touch screen 130 is a touch-sensitive display providing an interface for touch input/output between the electronic device 100 and the user. The touch screen 130 is a medium for detecting a touch through a touch sensor (not shown), transmitting the sensed touch input to the electronic device 100, and visually outputting output from the electronic device 100 to the user. The touch screen 130 provides visual output based on text, graphics, and video to the user in response to touch input.

The touch screen 130 includes a touch sensing surface for detecting the touch input of the user. The touch screen 130 detects touch input of the user by a haptic touch, a tactile touch, and a combined type of them. For example, a touch sensing point of the touch screen 130 corresponds to a width of a digit used in a touch on a touch sensing surface. The touch screen 130 detects a touch by an external device such as a stylus pen through a touch sensing surface. The touch screen 130 interworks with the touch sensing program 117 and detects a touch thereon. The detected touch is converted into interaction corresponding to a user interface target (e.g., a soft key) displayed on the touch screen 130.

The touch screen 130 provides an interface for touch input/output between the electronic device 100 and the user. The touch screen 130 is a medium for transmitting touch input of the user to the electronic device 100 and visually outputting output from the electronic device 100 to the user. The touch screen 130 may use various display technologies, such as a Liquid Crystal Display (LCD) technology, a Light Emitting Diode (LED) technology, a Light emitting Polymer Display (LPD) technology, an Organic Light Emitting Diode (OLED) technology, an Active Matrix Organic Light Emitting Diode (AMOLED) technology, and a Flexible LED (FLED) technology. The touch screen 130 is, however, not limited to the touch screen using these display technologies. The touch screen 130 may also detect the start of a touch on a touch sensing surface, the movement of the touch, or the stop or end of the touch using several touch detection (or sensing) technologies such as capacitive, resistive, infrared, and surface acoustic wave detection technologies. The touch screen 130 may detect at least one or more touches from the user and detect release of the touches. The touches detected by the touch screen 130 may be gestures such as taps, taps during a certain time, double taps, or drags. The touch screen 130 may detect touches for a position search bar and a reproduction control item from the user and sense the touch for the position search bar additionally in a state where the touch for the reproduction control item is held.

The vibration generating unit 140 may generate the vibration generated by the touch feedback program 119 through a vibration motor, a micro vibrator, and the like.

The humidity sensor 150 may sense a humidity change.

The audio controller 160 connects to a speaker 162 and a microphone 164 and performs an input and output function of an audio stream, such as a voice recognition function, a voice copy function, a digital recording function, and a phone call function. The audio controller 160 outputs an audio signal through the speaker 162 and receives a voice signal of the user through the microphone 164. The audio controller 160 receives a data stream through the processor 120, converts the received data stream into an electric stream, and transmits the converted electric stream to the speaker 162. The audio controller 160 receives a converted electric stream from the microphone 164, converts the received electric stream into an audio data stream, and transmits the converted audio data stream to the processor 120. The audio controller 160 may include an attachable and detachable earphone, headphone, or headset. The speaker 162 converts the electric stream received from the audio controller 160 into a sound wave to which people may listen and outputs the converted sound wave. The microphone 164 converts sound waves transmitted from people or other sound sources into electric streams. The audio controller 160 according to one embodiment of the present invention may output a sound effect generated by the touch feedback program 119.

FIG. 1B is a block diagram illustrating detailed configuration of a processor for outputting a touch feedback effect according to one exemplary embodiment of the present invention.

Referring to FIGS. 1A and 1B, the processor 120 includes a touch sensing processor 122, an image control processor 124, and a touch feedback processor 126.

The touch sensing processor 122 interworks with the touch screen 130 and detects a touch input on a touch sensing surface. The touch sensing processor 122 determines whether a touch is generated on a touch sensing surface, determines a movement of the touch, determines a movement direction and time of the touch, and determines whether the touch is stopped. Determining the movement of the touch may include determining a movement speed (magnitude), movement velocity (magnitude and direction), acceleration (including magnitude or/and direction) of the touch, and the like. The touch sensing processor 122 may detect a touch of the user and verify writing pressure and writing speed of the sensed touch. The writing pressure and writing speed of the touch may include writing pressure and writing speed. The writing pressure and writing speed of the touch may include pressure and movement speed of a touch which is provided to the touch screen 130.

The image control processor 124 displays an image. The displayed image includes the image material information 112. The image control processor 124 displays surface flexion and a surface feature of a target indicated by the image. The displayed target includes at least one of paper, metal, wood, plastic, stone, sand, skin, glass, and water. For example, the image control processor 124 may display an image indicating wood material or an image indicating plastic material.

When a touch is sensed by the touch sensing processor 122, the image control processor 124 may display writing data corresponding to the sensed touch on a displayed image. The image control processor 124 may display writing data on a displayed target in consideration of material of an image displayed by the touch feedback processor 126. For example, when a touch which progresses in a straight line on an image indicating wood material is detected, the image control processor 124 may display a line of a crooked shape partially on a portion where a change value of surface flexion is greater than or equal to a threshold value while the touch progresses in a straight line, in consideration of material information of wood indicated by the image, instead of displaying writing data of the straight line, and output an effect such as the user writes down the data directly on the wood. When a touch of a curve is detected on an image indicating sand material, the image control processor 124 may display an effect in which sand of a portion where the touch of the curve is input is dug and sand around the curve is thickly accumulated and output an effect such as the user writing data directly on sand. When a touch is detected on an image indicating water material, the image control processor 124 displays an effect in which environs of writing data are rippled according to the writing data corresponding to the sensed touch.

When humidity of a threshold value or more is detected by the humidity sensor 150, the image control processor 124 may display a front effect on a displayed image. When a touch is detect on the image having the frost effect, the image control processor 124 may display an effect in which the image is defrosted according to writing data corresponding to the detected touch.

The touch feedback processor 126 generates a feedback effect based on at least one of the writing pressure and writing speed of the touch verified by the touch sensing processor 122, the image material information 112, and the pen type information 113.

A touch is input to a surface of the touch screen 130 in which there is no flexion. According to an exemplary embodiment of the present invention, the touch feedback processor 126 generates a vibration effect such as the user inputting a touch to a corresponding target directly, in consideration of material information of the target indicated by an image. The touch feedback processor 126 generates a vibration effect based on material information mapped to a coordinate of an image to which a touch is input, tip of a touch subject, and speed and pressure of the touch subject. The touch feedback processor 126 may generate a vibration effect based on material information of an image according to a progress distance of a touch, a tip of a touch subject, and a speed and pressure of the touch subject.

The touch feedback processor 126 generates a vibration effect. The touch feedback processor 126 generates vibration per time point when the tip of a touch subject bumps against surface flexion of a displayed target in consideration of material information of a target indicated by a displayed image. For example, as shown in FIG. 1C, the touch feedback processor 126 generates vibration in time points 173 and 177 when the tip of a touch subject bumps in a section where a change value of a surface flexion of a displayed target is greater than or equal to a threshold value. The touch feedback processor 126 does not generate vibration in time points 171 and 175 when the tip of the touch subject is bumped in a section where a change value of the surface flexion is less than or equal to a threshold value, that is, a section which is similar to a plane. In addition, the quicker the writing speed of a touch, the quicker a time point when the tip of the touch subject bumps against a section where a change value of surface flexion of a displayed target is greater than or equal to a threshold value. Accordingly, the quicker the writing speed of the touch, the quicker the generation speed of vibration generated by the touch feedback processor 126.

In addition, the touch feedback processor 126 may adjust a strength of vibration according to a pressure of the touch sensed by the touch sensing processor 122 The stronger the intensity of the pressure of the touch detected by the touch sensing processor 122, the stronger the touch feedback processor 126 may set the strength of vibration. The touch feedback processor 126 may also adjust the strength of vibration according to a height at which touch subjects fall onto surface flexion of a displayed target. The higher the height at which the touch subjects fall onto the surface flexion of the displayed target, the stronger the touch feedback processor 126 increases the strength of vibration. The lower the height at which the touch subjects fall onto the surface flexion of the displayed target, the weaker the touch feedback processor 126 decreases the strength of vibration. For example, as shown in FIG. 1C, the touch feedback processor 126 may generate the strongest vibration in a time point 177 when height at which the touch subject falls is the highest height among time points 173 and 177 when vibration is generated.

The touch feedback processor 126 may adjust strength of vibration according to a writing instrument item selected by the user. The stronger the material strength of a selected writing instrument, the stronger the touch feedback processor 126 may increase strength of generated vibration. For example, when a ballpoint pen with strong material strength is selected among writing instruments, the touch feedback processor 126 may generate a stronger vibration than when a brush with weak material strength is selected. In addition, as shown in FIG. 1E, the electronic device 100 may calculate a vibration value based on vibration strength and a vibration generation time point.

In addition, the touch feedback processor 126 may generate a sound effect using the calculated vibration value. The touch feedback processor 126 may generate a sound at a time point when vibration is generated. The more the vibration strength is increased, the more the touch feedback processor 126 may increase the volume or frequency of a sound. The touch feedback processor 126 may also generate a sound effect according to material of a displayed image. For example, when a displayed image has paper material, the touch feedback processor 126 generates a sound effect generated by a writing instrument and paper when the user writes on paper. When a displayed image has wood material, the touch feedback processor 126 generates a sound effect generated by a writing instrument and wood when the user writes on wood. In addition, the touch feedback processor 126 may generate a graphic effect. The generated graphic effect may include an effect indicating a shape in which a target is changed according to target material of a displayed image when writing data is input. For example, when a touch is detected on an image indicating sand material, the touch feedback processor 126 displays an effect in which surrounding sand is scattered according to writing data corresponding to the detected touch. When a touch is detected on an image indicating water material, the touch feedback processor 126 displays an effect in which surrounding water is rippled according to writing data corresponding to the sensed touch.

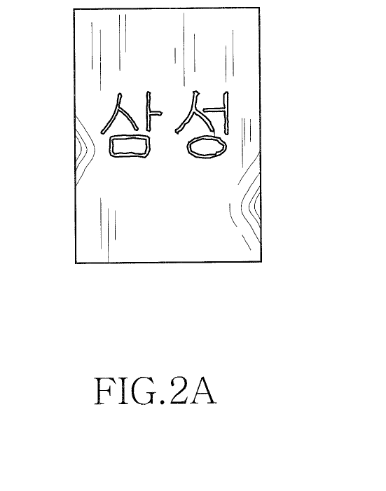

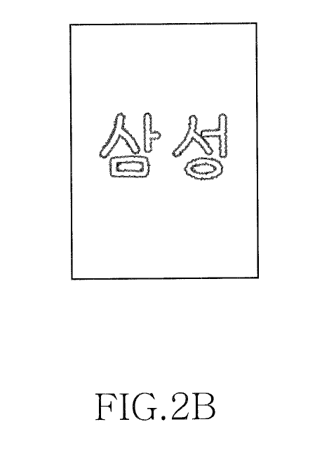

FIGS. 2A and 2B illustrate information which is written down on a wood material image and a sand material image in an electronic device according to one exemplary embodiment of the present invention.

Referring to FIGS. 1A, 2A, and 2B, as shown in FIG. 2A, when writing data for an image of wood material is input, the electronic device 100 may display writing data corresponding to an input touch, such as a user writes down the data actually on wood. The electronic device 100 may display writing data unevenly according to wood material information indicating surface flexion of a wood image. When a change value of surface flexion of a wood image corresponding to a coordinate where a touch is detected is less than or equal to a threshold value, the electronic device 100 displays writing data on the coordinate where the touch is detected. When a change value of the surface flexion of the wood image corresponding to the coordinate where the touch is detected is greater than or equal to a threshold value, the electronic device 100 displays writing data on a coordinate which is spaced apart at a certain distance or more from the coordinate where the touch is detected. When a change value of surface flexion is greater than or equal to a threshold value, the electronic device 100 may determine a distance for displaying writing data according to change quantity of the surface flexion.

Referring to FIG. 2B, when writing data for an image of sand material is input, the electronic device 100 may display writing data as a shape in which sand is dug in a portion corresponding to an input touch such as the user writes down the data actually on sand. The electronic device 100 may display an effect in which sand is dug in a portion of writing data corresponding to an input touch and sand around the writing data is accumulated according to sand material information indicating surface flexion of a sand image.

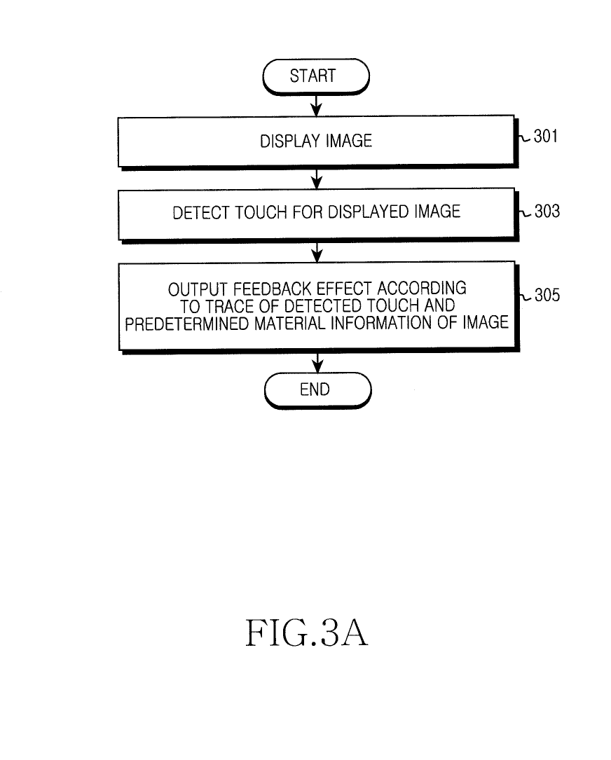

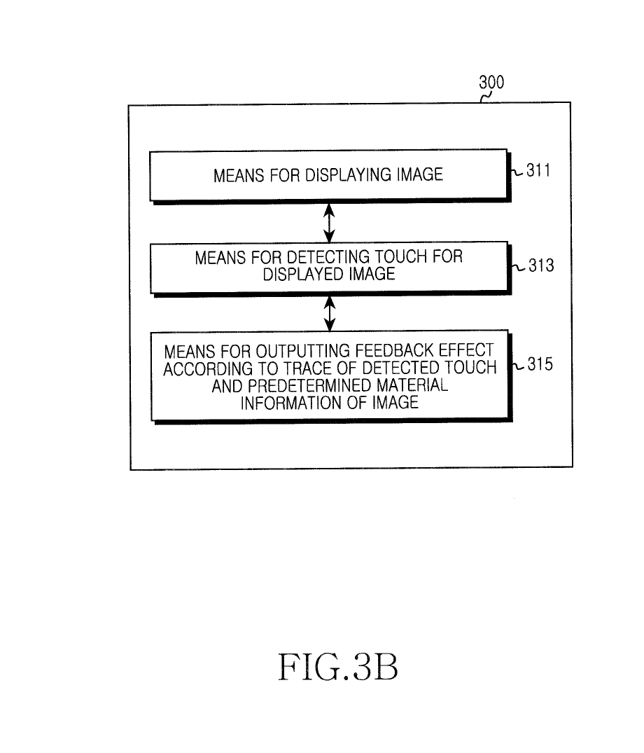

FIG. 3A is a flowchart illustrating a process of outputting a feedback effect for touch input in an electronic device according to an embodiment of the present invention.

Referring to FIGS. 1A and 3A, the electronic device 100 displays an image in operation 301. The displayed image includes an image indicating material of a specific target. The target includes at least one of paper, metal, wood, plastic, stone, sand, skin, glass, and water. The electronic device 100 detects a touch for the displayed image in operation 303. The electronic device 100 proceeds to operation 305 and outputs a feedback effect according to trace of the detected touch and predetermined material information of the image. The feedback effect includes at least one of a vibration effect, a sound effect, and a graphic effect. In order to provide an effect such as the user writing on a target of the displayed image, the electronic device 100 indicates a vibration effect and a sound effect according to surface flexion of a target in which a touch is input. The electronic device 100 may indicate a change of an image according to a material characteristic of the target when the touch is input as a graphic effect.

FIG. 3B is a block diagram illustrating configuration of an apparatus for outputting a feedback effect for touch input in an electronic device according to an embodiment of the present invention.

Referring to FIGS. 1A and 3B, the electronic device 100 includes a means 311 for displaying an image and a means 313 for detecting a touch for the displayed image. A touch subject includes at least one of fingers of the user, stylus pens, and other touch instruments. The electronic device 100 also includes a means 315 for outputting a feedback effect according to trace of the detected touch and predetermined material information of the image. The electronic device 100 may output a graphic effect through the touch screen 130. The electronic device 100 may output a vibration effect through the vibration generating unit 160. The electronic device 100 may output a sound effect through the speaker 162.

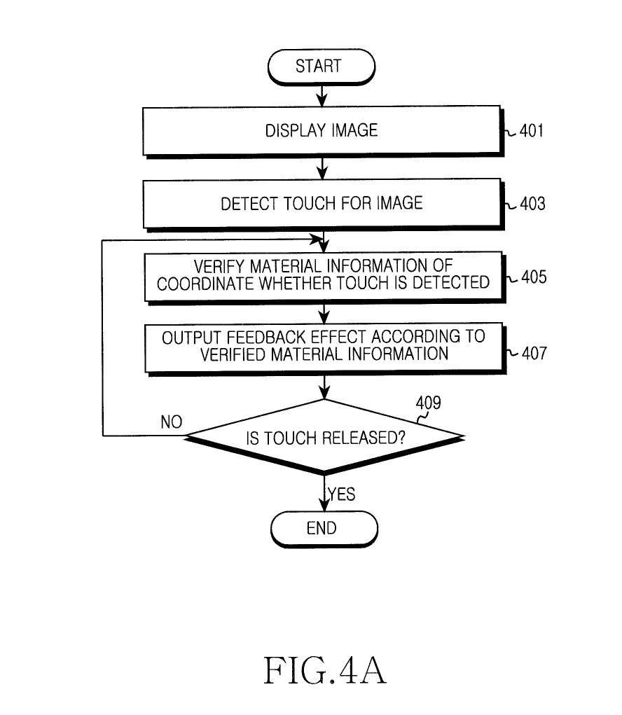

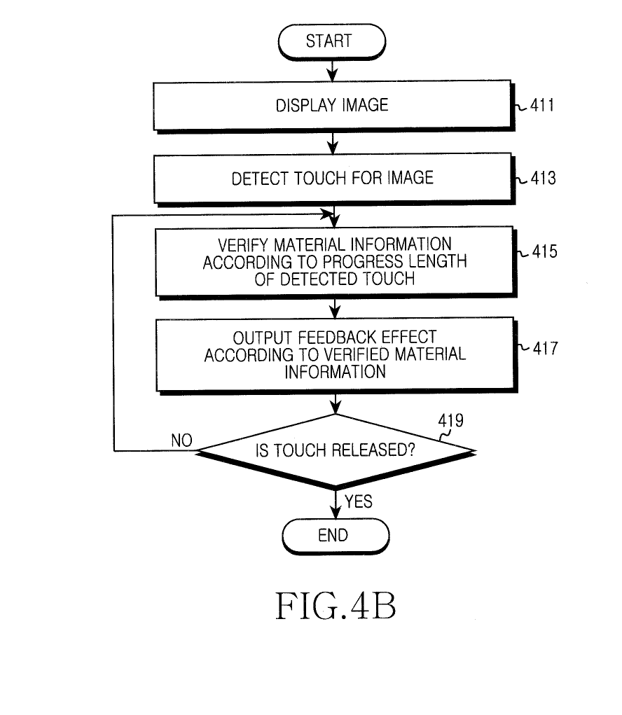

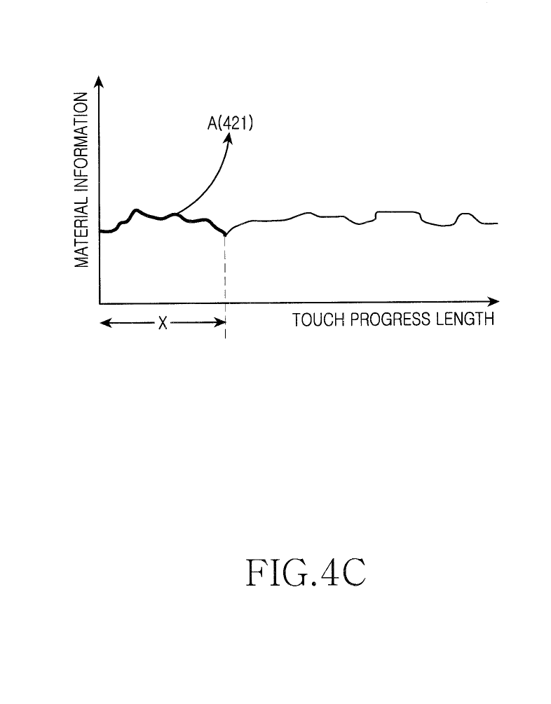

FIG. 4A is a flowchart illustrating a process of outputting a feedback effect according to material information of an image in touch input in an electronic device according to an embodiment of the present invention.

Referring to FIGS. 1A and 4A, the electronic device 100 displays an image in operation 401. The displayed image includes an image indicating material of a specific target. The target includes at least one of paper, metal, wood, plastic, stone, sand, skin, glass, and water. The electronic device 100 detects a touch for the displayed image in operation 403. The touch includes at least one of touches of all types such as touches of a tap type, a drag type, and a writing type. The electronic device 100 verifies material information of a coordinate where the touch is detected in operation 405. The electronic device 100 maps material information indicating surface flexion according to a target of the displayed image to each coordinate of the touch screen 130 in advance and stores material information by coordinates of the image according to the target of the displayed image. Accordingly, the electronic device 100 may verify material information mapped in advance by images on the coordinate where the touch is detected.

The electronic device 100 outputs a feedback effect according to the verified material information in operation 407. The electronic device 100 outputs a feedback effect according to the material information by coordinates of the image mapped to the coordinate where the touch is detected in advance. The electronic device 100 generates and outputs vibration, sound, and graphic effects according to surface flexion indicated by the material information of the coordinate where the touch is input. If an image target has relatively uneven material as a result of verifying the material information of the coordinate where the touch is detected, the electronic device 100 may display a strong vibration effect, a high volume effect, and a graphic effect according to the material of the image. On the other hand, if an image target has relatively even material as a result of verifying the material information of the coordinate where the touch is detected, the electronic device 100 may display weak vibration, low volume, and graphic according to the material of the image.

The electronic device 100 verifies whether the detected touch is released in operation 409. If the detected touch is not released, the electronic device 100 returns to operation 405. On the other hand, if the detected touch is released, the electronic device 100 ends the algorithm of FIG. 4A.

FIG. 4B is a flowchart illustrating a process of outputting a feedback effect according to material information of an image in touch input in an electronic device according to an embodiment of the present invention, and FIG. 4C illustrates a process of verifying material information of a stored image according to a touch progress length in an electronic device according to an embodiment of the present invention.

Referring to FIGS. 1A, 4B, and 4C, the electronic device 100 displays an image in operation 411. The displayed image includes an image indicating a material of a specific target. The target includes at least one of paper, metal, wood, plastic, stone, sand, skin, glass, and water. The electronic device 100 detects a touch for the displayed image in operation 413. Herein, the touch includes at least one of touch of all types, such as touches of a tap type, a drag type, and a writing type. The electronic device 100 verifies material information according to a progress length of the detected touch in operation 415. The electronic device 100 stores material information by targets of the displayed image while being classified according to the touch progress length and verifies material information according to the length at which the touch progresses on the image, irrespective of a coordinate of the image on which the touch is sensed. For example, as shown in FIG. 4C, whenever the progress length of the touch on the image progresses by X, the electronic device 100 may verify material information A 421 corresponding to an X interval.

The electronic device 100 outputs a feedback effect according to the verified material information in operation 417. The electronic device 100 outputs a feedback effect based on material information of an image mapped in advance according to the progress length of the touch.

If an image target has relatively uneven material as a result of verifying the material information of the coordinate where the touch is detected, the electronic device 100 may display a strong vibration effect, a high volume effect, and a graphic effect according to the material of the image. On the other hand, if an image target has relatively even material as a result of verifying the material information of the coordinate where the touch is detected, the electronic device 100 may display weak vibration, low volume, and graphic according to the material of the image.

The electronic device 100 verifies whether the detected touch is released in operation 419. If the detected touch is not released, the electronic device 100 returns to operation 415. On the other hand, if the detected touch is released, the electronic device 100 ends the algorithm of FIG. 4B.

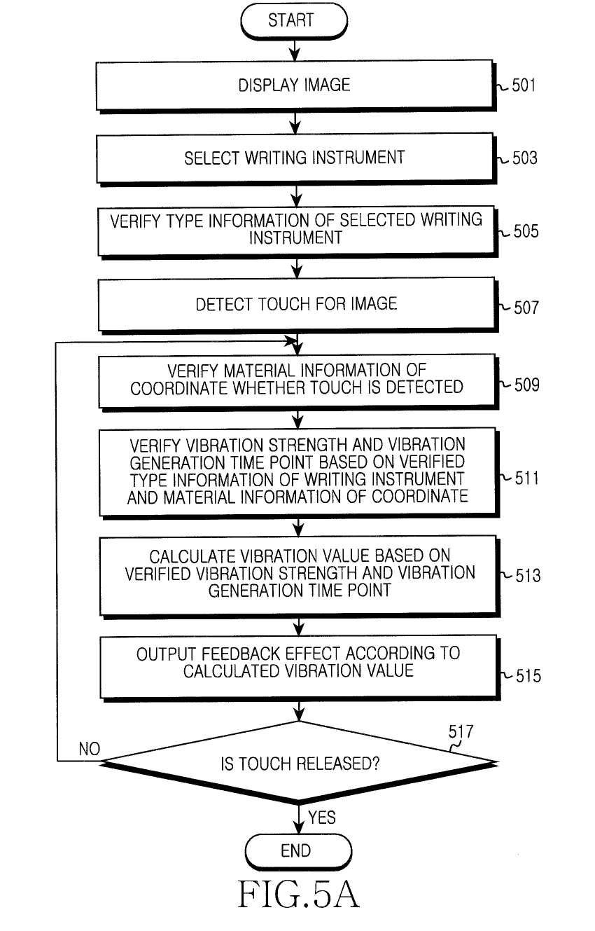

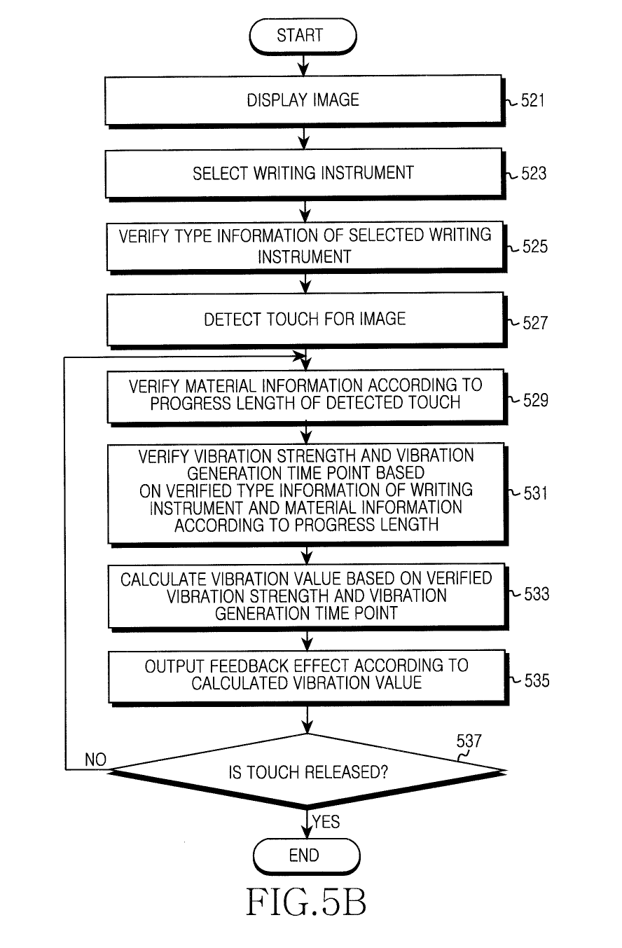

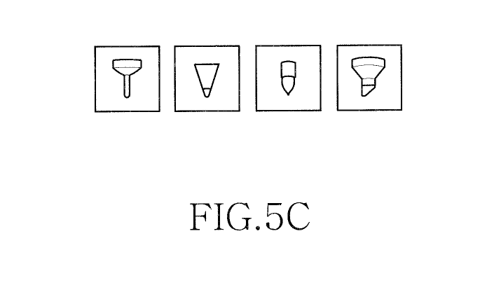

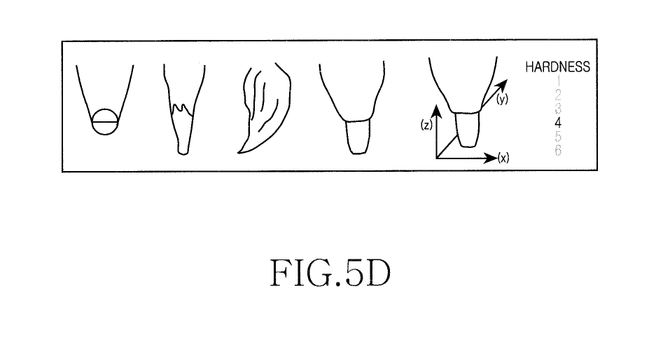

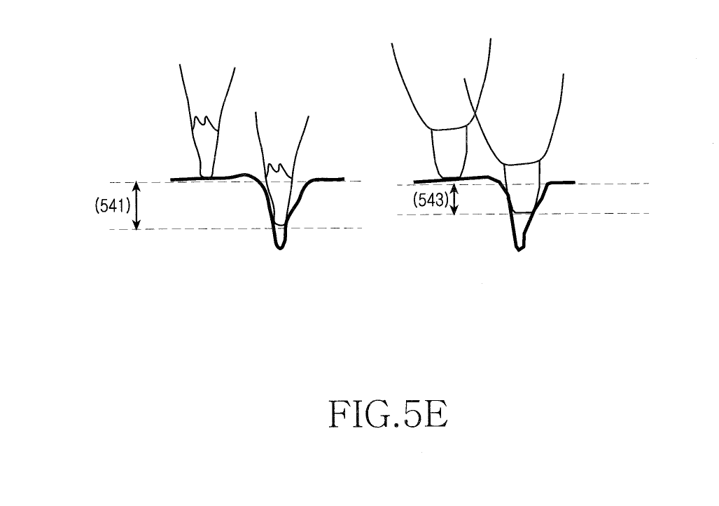

FIG. 5A is a flowchart illustrating a process of outputting a feedback effect for touch input in the touch input using a writing instrument in an electronic device according to an embodiment of the present invention. FIG. 5C illustrates writing instrument icons in an electronic device according to an embodiment of the present invention. FIG. 5E illustrates a process of determining vibration strength by writing instruments in an electronic device according to an embodiment of the present invention

Referring to FIGS. 1A, 5A, 5C, and 5E, the electronic device 100 displays an image in operation 501. The displayed image includes an image indicating material of a specific target. The target includes at least one of paper, metal, wood, plastic, stone, sand, skin, glass, and water. The electronic device 100 selects a writing instrument item in operation 503. The electronic device 100 verifies type information of a selected writing instrument in operation 505. Type information of a pen includes information indicating features of the pen, such as hardness, thickness, and strength of a pen tip. For example, as shown in FIG. 5C, when a displayed writing instrument item is selected after writing instrument items are displayed, the electronic device 100 may verify type information of writing instruments, which is previously sampled and stored.

The electronic device 100 detects a touch for the displayed image in operation 507. When a specific writing instrument item is selected, the electronic device 100 operates such as a user touches an image using the specific writing instrument item. For example, when a brush item is selected as a writing instrument item, the electronic device 100 may display an image of a brush on a coordinate where a touch is detected whenever the touch is detected.

The electronic device 100 verifies material information of a coordinate where the touch is detected in operation 509. The electronic device 100 maps material information indicating surface flexion according to a target of the displayed image to each coordinate of the touch screen 130 in advance and stores material information by coordinates of the image according to the target of the displayed image. Accordingly, the electronic device 100 may verify material information mapped in advance by images on the coordinate where the touch is detected.

The electronic device 100 determines a vibration strength and a vibration generation time point in operation 511 based on the verified type information of the writing instrument and the material information of the coordinate where the touch is input. The electronic device 100 may determine a time point when a tip of the selected writing instrument bumps against a flexion of the coordinate where the touch is detected as the vibration generation time point. The electronic device 100 may also adjust a vibration strength according to a height at which touch subjects falls on flexion of a displayed target and a material strength of the selected writing instrument. For example, as shown in FIG. 5E, when a user writes down data using a pencil and a highlighter under the same condition, because height 541 at which a pencil tip falls is higher than height 543 at which a highlighter tip falls, the electronic device 100 may adjust vibration strength to be stronger when the pencil is selected than when the highlighter is selected.

The electronic device 100 calculates a vibration value in operation 513 based on the adjusted vibration strength and the vibration generation time point. The electronic device 100 outputs a feedback effect according to the calculated vibration value in operation 515. The electronic device 100 outputs vibration and sound effects in a time point when the vibration value is generated and outputs a graphic effect according to material of the corresponding image. The electronic device 100 may also adjust an amplitude of the output vibration and sound effects according to amplitude of the vibration value and may adjust the output graphic effect according to the material of the corresponding image. For example, when an image of sand material is displayed, the electronic device 100 may adjust a vibration effect according to a calculated vibration value, adjust volume of a sound such as the user writing on sand, and graphically adjust an amount of sand which is dug by writing and is accumulated around the written data.

The electronic device 100 verifies whether the detected touch is released in operation 517. If the detected touch is not released, the electronic device 100 returns to operation 509. On the other hand, if the detected touch is released, the electronic device 100 ends the algorithm of FIG. 5A.

FIG. 5B is a flowchart illustrating a process of outputting a feedback effect for touch input in the touch input using a writing instrument in an electronic device according to an embodiment of the present invention.

Referring to FIGS. 1A, 5B, and 5D, the electronic device 100 displays an image in operation 521. The displayed image includes an image indicating material of a specific target. The target includes at least one of paper, metal, wood, plastic, stone, sand, skin, glass, and water. The electronic device 100 selects a writing instrument item in operation 523. The electronic device 100 verifies type information of a selected writing instrument in operation 525. Type information of a pen means information indicating features of the pen, such as hardness, thickness, and strength of a pen tip. FIG. 5D shows examples of different types of a pen.

The electronic device 100 detects a touch for the displayed image in operation 527. When a specific writing instrument item is selected, the electronic device 100 operates such as a user touches an image using the specific writing instrument item.

The electronic device 100 verifies material information according to a progress length of the detected touch in operation 529. The electronic device 100 stores material information by targets of the displayed image while being classified according to touch progress lengths and verifies material information according to a length at which the touch progresses on the image, irrespective of a coordinate of an image on which a touch is detected. If a touch having the same progress length on a specific image is detected, the electronic device 100 always verifies the same material information on the specific image irrespective of a position where the touch is sensed.

The electronic device 100 verifies vibration strength and a vibration generation time point in operation 531 based on the verified type information of the writing instrument and the material information according to the progress length at which the touch is input. The electronic device 100 may determine a time point when a tip of the selected writing instrument bumps against flexion of image material verified according to the touch progress length as the vibration generation time point. The electronic device 100 may also adjust a vibration strength according to height at which touch subjects falls on a flexion of a displayed target and material strength of the selected writing instrument.

The electronic device 100 calculates a vibration value in operation 533 based on the adjusted vibration strength and the vibration generation time point. The electronic device 100 outputs a feedback effect according to the calculated vibration value in operation 535. The electronic device 100 outputs vibration and sound effects in a time point when the vibration value is generated and outputs a graphic effect according to material of the corresponding image. The electronic device 100 may also adjust an amplitude of the output vibration and sound effects according to amplitude of the vibration value and adjust the output graphic effect according to the material of the corresponding image.

The electronic device 100 verifies whether the detected touch is released in operation 537. If the detected touch is not released, the electronic device 100 returns to operation 529. On the other hand, if the detected touch is released, the electronic device 100 ends the algorithm of FIG. 5B.

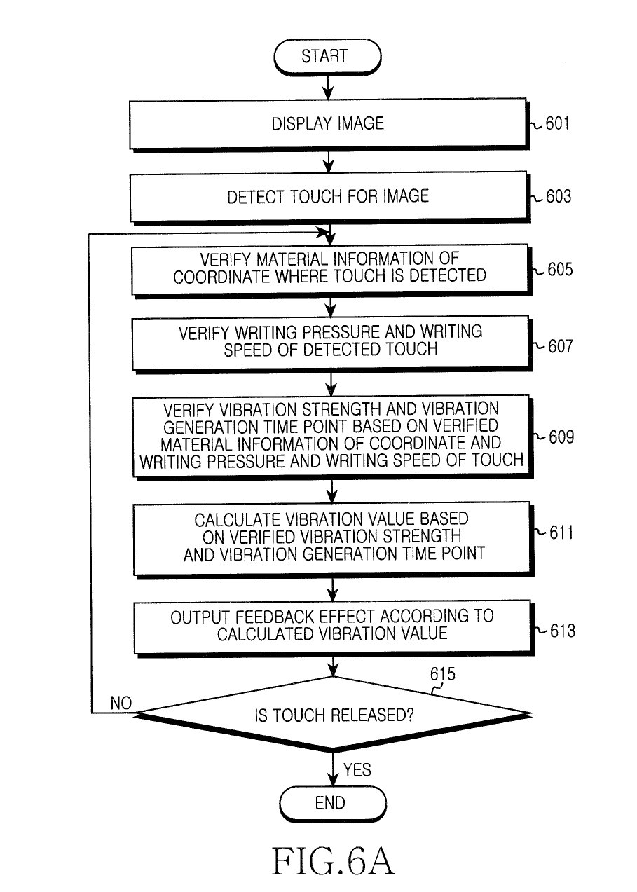

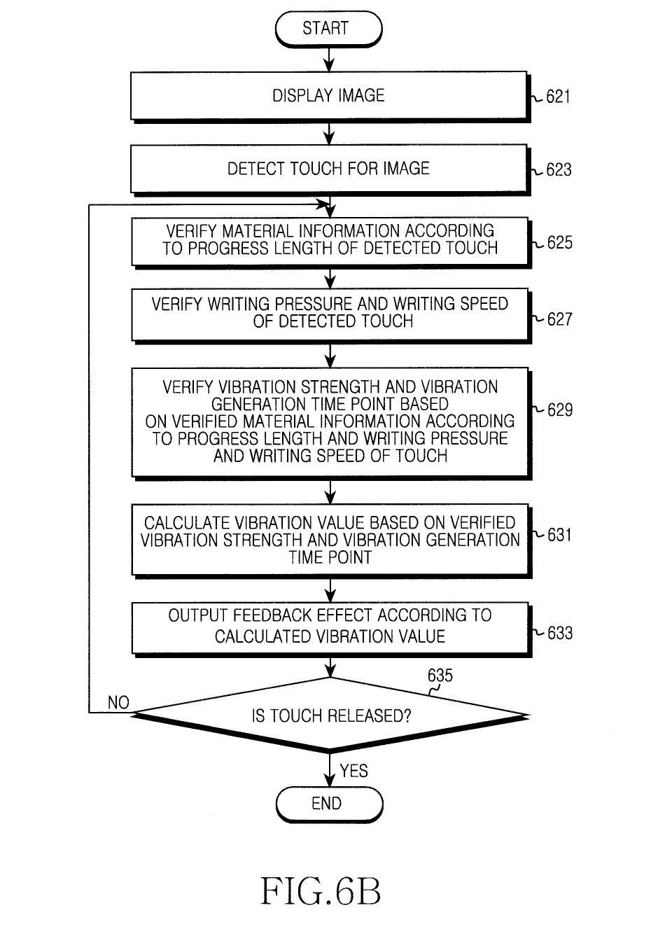

FIG. 6A is a flowchart illustrating a process of outputting a feedback effect based on writing pressure and writing speed of a touch in the touch input in an electronic device according to an embodiment of the present invention.

Referring to FIGS. 1A and 6A, the electronic device 100 displays an image in operation 601. The displayed image includes an image indicating material of a specific target. The target includes at least one of paper, metal, wood, plastic, stone, sand, skin, glass, and water. The electronic device 100 detects a touch for the displayed image in operation 603. The electronic device 100 verifies material information of a coordinate where the touch is detected in operation 605. The electronic device 100 maps material information indicating a surface flexion according to a target of the displayed image to each coordinate of the touch screen 130 in advance and stores material information by coordinates of the image according to the target of the displayed image. Accordingly, the electronic device 100 may verify material information mapped in advance by images on the coordinate where the touch is detected.

The electronic device 100 verifies a writing pressure and a writing speed of the detected touch in operation 607. The electronic device 100 determines vibration strength and a vibration generation time point in operation 609 based on the verified material information of the coordinate and the writing pressure and writing speed of the touch. The electronic device 100 may determine that vibration is generated per time point when a tip of the detected touch bumps against a flexion of the detected coordinate. The electronic device 100 may also adjust a vibration strength according to the writing pressure and the writing speed of the detected touch and a height at which touch subjects falls on a flexion of a displayed target. The more the writing pressure of the detected touch is increased, the more the electronic device 100 may increase vibration strength. The more the writing speed of the detected touch is increased, the more the electronic device 100 quickens the vibration generation time point.

The electronic device 100 calculates a vibration value in operation 611 based on the adjusted vibration strength and the vibration generation time point. The electronic device 100 outputs a feedback effect in operation 613 according to the calculated vibration value. The electronic device 100 outputs vibration and sound effects at a time point when the vibration value is generated and outputs a graphic effect according to material of the corresponding image. The electronic device 100 may also adjust an amplitude of the output vibration and sound effects according to amplitude of the vibration value and adjust the output graphic effect according to the material of the corresponding image.

The electronic device 100 verifies whether the detected touch is released in operation 615. If the detected touch is not released, the electronic device 100 returns to operation 605. On the other hand, if the detected touch is released, the electronic device 100 ends the algorithm of FIG. 6A.

FIG. 6B is a flowchart illustrating a process of outputting a feedback effect based on writing pressure and writing speed of a touch in the touch input in an electronic device according to an embodiment of the present invention.

Referring to FIGS. 1A and 6B, the electronic device 100 displays an image in operation 621. The displayed image includes an image indicating material of a specific target. The target includes at least one of paper, metal, wood, plastic, stone, sand, skin, glass, and water. The electronic device 100 detects a touch for the displayed image in operation 623. The electronic device 100 verifies material information according to a progress length of the detected touch in operation 625. The electronic device 100 verifies the progress length of the detected touch and verifies material information corresponding to the progress length of the touch.

The electronic device 100 verifies a writing pressure and a writing speed of the detected touch in operation 627. The electronic device 100 verifies a vibration strength and a vibration generation time point in operation 629 based on the verified material information of the coordinate and the writing pressure and writing speed of the touch. The electronic device 100 may determine a time point when a tip of the detected touch bumps against a flexion of the image material verified according to the touch progress length as the vibration generation time point. The electronic device 100 may also adjust a vibration strength according to height at which touch subjects falls on a flexion of a displayed target. The stronger the writing pressure of the detected touch, the stronger the electronic device 100 may adjust vibration strength. The quicker the writing speed of the detected touch, the quicker the electronic device 100 may adjust a vibration generation time point.

The electronic device 100 calculates a vibration value in operation 631 based on the adjusted vibration strength and the vibration generation time point. The electronic device 100 outputs a feedback effect according to the calculated vibration value in operation 633. The electronic device 100 outputs vibration and sound effects at a time point when the vibration value is generated and outputs a graphic effect according to material of the corresponding image. The electronic device 100 may adjust an amplitude of the output vibration and sound effects according to an amplitude of the vibration value and may adjust the output graphic effect according to the material of the corresponding image.

The electronic device 100 verifies whether the detected touch is released in operation 635. If the detected touch is not released, the electronic device 100 returns to operation 625. On the other hand, if the detected touch is released, the electronic device 100 ends the algorithm of FIG. 6B.

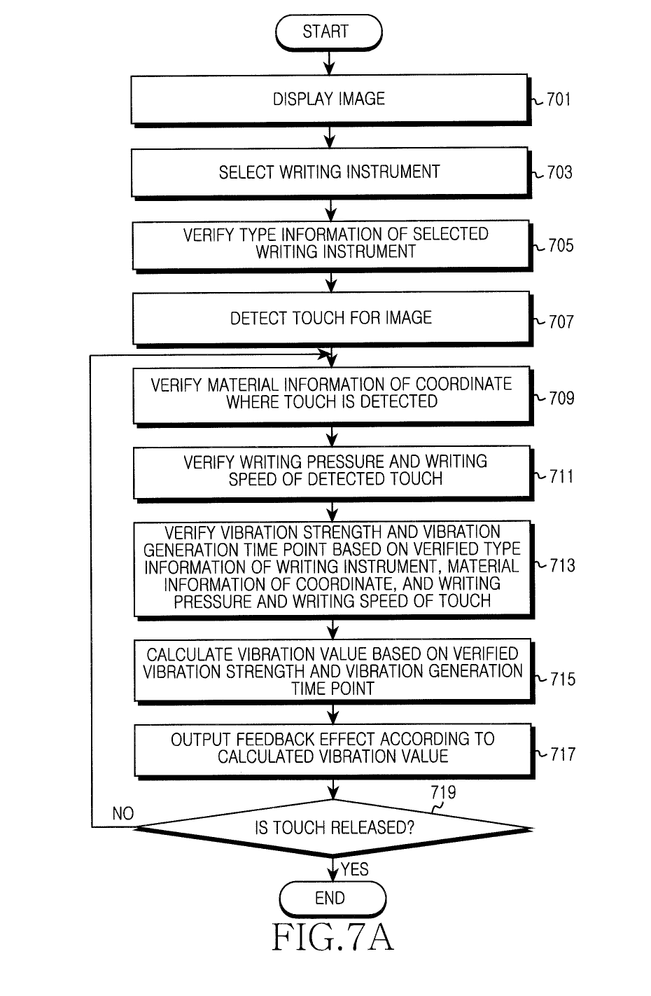

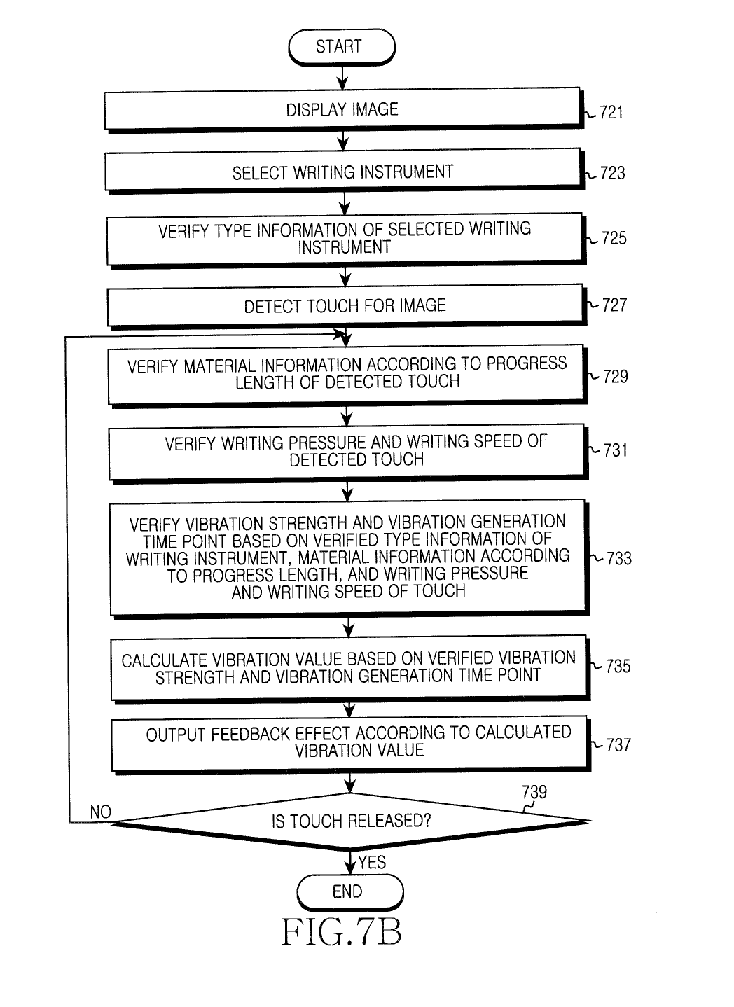

FIG. 7A is a flowchart illustrating a process of outputting a feedback effect based on writing pressure and writing speed in the touch input using a writing instrument in an electronic device according to an embodiment of the present invention.

Referring to FIGS. 1A and 7A, the electronic device 100 displays an image in operation 701. The displayed image includes an image indicating a material of a specific target. The target includes at least one of paper, metal, wood, plastic, stone, sand, skin, glass, and water. The electronic device 100 selects a writing instrument item in operation 703. The electronic device 100 verifies type information of a selected writing instrument in operation 705. Type information of a pen includes information indicating features of the pen, such as hardness, thickness, and strength of a pen tip.

The electronic device 100 detects a touch for the displayed image in operation 707. When a specific writing instrument item is selected, the electronic device 100 operates such as a user touches the image using the specific writing instrument item.

The electronic device 100 verifies material information of a coordinate where the touch is detected in operation 709. The electronic device 100 maps material information indicating a surface flexion according to a target of the displayed image to each coordinate of the touch screen 130 in advance and stores material information by coordinates of the image according to the target of the displayed image. Accordingly, the electronic device 100 may verify material information mapped in advance by images on the coordinate where the touch is detected.

The electronic device 100 verifies a writing pressure and a writing speed of the detected touch in operation 711. The electronic device 100 determines a vibration strength and a vibration generation time point in operation 713 based on the verified type information of the writing instrument, the verified material information of the coordinate where the touch is input, and the writing pressure and writing speed of the touch. The electronic device 100 may determine a time point when a tip of the verified writing instrument bumps against a flexion of the coordinate on which the touch is detected as the vibration generation time point. The electronic device 100 may also adjust a vibration strength according to the writing pressure and the writing speed of the detected touch, a height at which the selection writing instrument falls on a flexion of a displayed target, and a material strength of the selected writing instrument. The more the writing pressure of the detected touch is increased, the more the electronic device 100 may increase vibration strength. The more the writing speed of the detected touch is increased, the more the electronic device 100 quickens the vibration generation time point.

The electronic device 100 calculates a vibration value in operation 715 based on the adjusted vibration strength and the vibration generation time point. The electronic device 100 outputs a feedback effect according to the calculated vibration value in operation 717. The electronic device 100 outputs vibration and sound effects at a time point when the vibration value is generated and outputs a graphic effect according to material of the corresponding image. The electronic device 100 may also adjust an amplitude of the output vibration and sound effects according to an amplitude of the vibration value and adjust the output graphic effect according to the material of the corresponding image.

The electronic device 100 verifies whether the detected touch is released in operation 719. If the detected touch is not released, the electronic device 100 returns to operation 709. On the other hand, if the detected touch is released, the electronic device 100 ends the algorithm of FIG. 7A.

FIG. 7B is a flowchart illustrating a process of outputting a feedback effect based on writing pressure and writing speed in the touch input using a writing instrument in an electronic device according to an embodiment of the present invention.

Referring to FIGS. 1A and 7B, the electronic device 100 displays an image in operation 721. The displayed image includes an image indicating material of a specific target. The target includes at least one of paper, metal, wood, plastic, stone, sand, skin, glass, and water. The electronic device 100 selects a writing instrument item in operation 723. The electronic device 100 verifies type information of a selected writing instrument in operation 725. Type information of a pen includes information indicating features of the pen, such as hardness, thickness, and strength of a pen tip.

The electronic device 100 detects a touch for the displayed image in operation 727. When a specific writing instrument item is selected, the electronic device 100 operates such as a user touches the image using the specific writing instrument item.

The electronic device 100 verifies material information according to a progress length of the detected touch in operation 729. The electronic device 100 verifies the progress length of the detected touch and verifies material information corresponding to the progress length of the touch.

The electronic device 100 verifies a writing pressure and a writing speed of the detected touch in operation 731. The electronic device 100 verifies a vibration strength and a vibration generation time point in operation 733 based on the verified type information of the writing instrument, the verified material information according to the progress length at which the touch is input, and the writing pressure and writing speed of the touch. The electronic device 100 may determine a time point when a tip of the selected writing instrument bumps against a flexion of the image material verified according to the touch progress length as the vibration generation time point. The electronic device 100 may also adjust a vibration strength according to a height at which touch subjects falls on a flexion of a displayed target and material strength of the selected writing instrument. The stronger the writing pressure of the detected touch, the stronger the electronic device 100 may adjust the vibration strength. The quicker the writing speed of the detected touch, the quicker the electronic device 100 may adjust a vibration generation time point.

The electronic device 100 calculates a vibration value in operation 735 based on the adjusted vibration strength and the vibration generation time point. The electronic device 100 outputs a feedback effect according to the calculated vibration value in operation 737. The electronic device 100 outputs vibration and sound effects at a time point when the vibration value is generated and outputs a graphic effect according to material of the corresponding image. The electronic device 100 may also adjust an amplitude of the output vibration and sound effects according to an amplitude of the vibration value and adjust the output graphic effect according to the material of the corresponding image.

The electronic device 100 verifies whether the detected touch is released in operation 739. If the detected touch is not released, the electronic device 100 returns to operation 729. On the other hand, if the detected touch is released, the electronic device 100 ends the algorithm of FIG. 7B.

As described above, the electronic device 100 outputs a vibration effect according to material information of an image. However, in accordance with a design scheme, an electronic pen may output a vibration effect according to material information of an image. For example, when the electronic pen includes a vibration generating unit, the electronic pen itself may output a vibration effect according to material information of an image.

Embodiments and all function operations of the present invention described in herein may be executed by one or more of computer software, firmware, or hardware, which include structures disclosed in the specification of the present invention and equivalent structures of them. Also, embodiments of the present invention described in the specification of the present invention may be implemented by one or more computer program products, that is, one or more modules of computer program instructions, which are executed by data processing devices or are encoded on a computer readable medium for controlling operations of these devices.

The computer readable medium may be one or more of a non-transitory machine readable storage medium, a machine readable storage board, a memory device, composition of materials which have an influence on a machine readable propagation stream. The term “data processing device” includes a programmable processor, a computer, or all devices, apparatuses, and machines, including a multi-processor or a computer, for processing data. The devices may include one or more of codes for being added in hardware and generating execution environments for a corresponding computer program, for example, codes configuring processor firmware, a protocol stack, a database management system, an operating system.

While the invention has been shown and described with reference to exemplary embodiments thereof, it will be understood by those skilled in the art that various changes in form and details may be made therein without departing from the spirit and scope of the present invention as defined by the appended claims and their equivalents.

What is claimed is:

1. A method in an electronic device, the method comprising:
displaying an image;
detecting a touch for the displayed image; and
outputting a feedback effect according to a trace of the detected touch and previously stored material information of the image,
wherein the material information includes at least one of a flexion, a strength, and a friction coefficient of a target indicated by the image and information in which a surface of the target is sampled.

2. The method of claim 1, wherein the outputting of the feedback effect according to the trace of the detected touch and the previously stored material information of the image comprises outputting at least one of vibration, sound, and graphic effects based on material information of the image, which is mapped to a coordinate where the touch is detected in advance.

3. The method of claim 1, wherein the outputting of the feedback effect according to the trace of the detected touch and the previously stored material information of the image comprises outputting at least one of vibration, sound, and graphic effects based on material information of the image according to a progress length of the detected touch.

4. The method of claim 1, wherein the outputting of the feedback effect according to the trace of the detected touch and the previously stored material information of the image comprises:
verifying a surface flexion indicated by material information of the image, which corresponds to the trace of the detected touch;
determining a height at which a subject of the detected touch falls according to the surface flexion;
determining at least one of a vibration strength and a sound level according to the determined height; and
outputting at least one of vibration and a sound according to the determined vibration strength and sound level.

5. The method of claim 1, wherein the outputting of the feedback effect according to the trace of the detected touch and the previously stored material information of the image comprises:
verifying a surface flexion indicating material information of the image, which corresponds to the trace of the detected touch;
determining a feedback effect generation time point according to the surface flexion; and
outputting at least one of a vibration and a sound according to the determined feedback effect generation time point.

6. The method of claim 1, wherein the outputting of the feedback effect according to the trace of the detected touch and the previously stored material information of the image comprises:
determining at least one of a vibration strength and a sound level based on the trace of the detected touch and the previously stored material information of the image;
adjusting at least one of the determined vibration strength and the determined sound level based on a pressure of the detected touch; and
outputting at least one of vibration and a sound according to the adjusted vibration strength and sound level.

7. The method of claim 1, wherein the outputting of the feedback effect according to the trace of the detected touch and the previously stored material information of the image comprises:
determining a writing instrument type for the detected touch; and
outputting a feedback effect based on the trace of the detected touch, the previously stored material information of the image, and the writing instrument type,
wherein the writing instrument type includes at least one of a hardness, a thickness, and a strength of a writing instrument tip.

8. The method of claim 1, wherein the outputting of the feedback effect according to the trace of the detected touch and the previously stored material information of the image comprises:
deleting a graphic displayed on a coordinate where the touch is detected,
wherein the deleting of the graphic displayed on the coordinate where the touch is detected comprises, when the displayed image is an image of frosted glass material, deleting a frost image displayed on the coordinate where the touch is detected.

9. The method of claim 1, wherein the outputting of the feedback effect according to the trace of the detected touch and the previously stored material information of the image comprises:
verifying a surface flexion indicating material information of the image, which corresponds to the trace of the detected touch;
verifying whether a change value of the verified surface flexion is greater than or equal to a threshold value; and
displaying writing data on a coordinate which is spaced apart from a coordinate of the detected touch at a certain distance or more when the change value of the verified surface flexion is greater than or equal to the threshold value,
wherein the displaying of the writing data on the coordinate which is spaced apart from the coordinate of the detected touch at the certain distance or more when the change value of the verified surface flexion is greater than or equal to the threshold value comprises:
determining a distance for displaying the writing data according to a change quantity of a surface flexion of a wood image when the displayed image is an image of wood material; and
displaying the writing data on the coordinate which is spaced apart from the detected coordinate by the determined distance.

10. The method of claim 1, wherein the outputting of the feedback effect according to the trace of the detected touch and the previously stored material information of the image comprises:
displaying writing data on a coordinate where the touch is detected; and
displaying a graphic effect corresponding to material information of the image around the coordinate where the touch is detected,
wherein the displaying of the graphic effect corresponding to the material information of the image around the coordinate where the touch is detected comprises:
displaying an effect in which sand is accumulated around the coordinate where the touch is detected when the displayed image is an image of sand material.

11. An electronic device comprising:
at least one processor;
a touch-sensitive display;
at least one feedback output device;
a memory; and
one or more programs, each of which are stored in the memory and configured to be executed by the one or more processors,
wherein the programs include an instruction for displaying an image, for detecting a touch for the displayed image, and for outputting a feedback effect according to a trace of the detected touch and previously stored material information of the image,
wherein the at least one feedback output device includes at least one of a display device, a vibration generating device, and a sound output device, and
wherein the material information includes at least one of a flexion, a strength, and a friction coefficient of a target indicated by the image and information in which a surface of the target is sampled.

12. The device of claim 11, wherein the programs include an instruction for outputting at least one of a vibration, a sound, and graphic effects based on material information of the image, which is mapped to a coordinate where the touch is detected in advance.

13. The device of claim 11, wherein the programs include an instruction for outputting at least one of a vibration, a sound, and a graphic effect based on material information of the image according to a progress length of the detected touch.

14. The device of claim 11, wherein the programs include an instruction for verifying a surface flexion indicated by material information of the image, which corresponds to the trace of the detected touch, for determining a height at which a subject of the detected touch falls according to the surface flexion, determining at least one of a vibration strength and a sound level according to the determined height, and for outputting at least one of a vibration and a sound according to the determined vibration strength and sound level.

15. The device of claim 11, wherein the programs include an instruction for verifying a surface flexion indicating material information of the image, which corresponds to the trace of the detected touch, for determining a feedback effect generation time point according to the surface flexion, and for outputting at least one of a vibration and a sound according to the determined feedback effect generation time point.

16. The device of claim 11, wherein the programs include an instruction for determining at least one of a vibration strength and a sound level based on the trace of the detected touch and the previously stored material information of the image, for adjusting at least one of the determined vibration strength and the determined sound level based on a pressure of the detected touch, and for outputting at least one of a vibration and a sound according to the adjusted vibration strength and sound level.

17. The device of claim 11, wherein the programs include an instruction for determining a writing instrument type for the detected touch and for outputting a feedback effect based on the trace of the detected touch, the previously stored material information of the image, and the writing instrument type, and
wherein the writing instrument type includes at least one of a hardness, a thickness, and a strength of a writing instrument tip.

18. The device of claim 11, wherein the programs include an instruction for deleting a graphic displayed on a coordinate where the touch is detected and for, when the displayed image is an image of frosted glass material, deleting a frost image displayed on the coordinate where the touch is detected.

19. The device of claim 11, wherein the programs include an instruction for verifying a surface flexion indicating material information of the image, which corresponds to the trace of the detected touch, for verifying whether a change value of the verified surface flexion is greater than or equal to a threshold value, for displaying writing data on a coordinate which is spaced apart from a coordinate of the detected touch at a certain distance or more when the change value of the verified surface flexion is greater than or equal to the threshold value, for determining a distance for displaying the writing data according to change quantity of surface flexion of a wood image when the displayed image is an image of wood material, and for displaying the writing data on the coordinate which is spaced apart from the detected coordinate by the determined distance.

20. The device of claim 11, wherein the programs include an instruction for displaying writing data on a coordinate where the touch is detected, for displaying a graphic effect corresponding to material information of the image around the coordinate where the touch is detected, and for displaying an effect in which sand is accumulated around the coordinate where the touch is detected when the displayed image is an image of sand material.
